(19) United States
(12) Patent Application Publication
(10) Pub. No.: US 2026/0195144 A1
(43) Pub. Date: Jul. 9, 2026

(54) MAPPING CONTAINER PROCESSES TO INDIVIDUAL CONTAINER LAYERS IN A COMPUTING ENVIRONMENT

(71) Applicant: Red Hat, Inc., Raleigh, NC (US)

(72) Inventors: Leigh Griffin, Waterford (IE); Pierre-Yves Chibon, Puteaux (FR)

(73) Assignee: Red Hat, Inc., Raleigh, NC (US)

(21) Appl. No.: 19/014,162

(22) Filed: Jan. 8, 2025

(51) Int. Cl. G06F 9/445; G06F 9/455; G06F 21/62

(52) U.S. Cl. CPC G06F 9/44521; G06F 9/455; G06F 21/6281

(57) ABSTRACT

A mapper service can be implemented to map container processes to individual container layers. For example, the mapper service can receive a container file executable to generate one or more container layers of a container image in a computing environment. The mapper service can determine one or more processes associated with the container image in the computing environment. Each process of the one or more processes can be generated by a respective container layer of the container file. Based on the container file, the mapper service can determine a respective mapping of each process to a corresponding container layer. The mapper service can generate a mapping file indicating the respective mapping of each process to the corresponding container layer.

### TECHNICAL FIELD

The present disclosure relates generally to software development. More specifically, but not by way of limitation, this disclosure relates to mapping container processes to individual container layers in a computing environment.

### BACKGROUND

Software services such as applications, serverless functions, and microservices can be deployed inside containers within a computing environment. A container is a relatively isolated virtual computing environment created by leveraging the resource isolation features (e.g., cgroups and namespaces) of the Linux Kernel. Deploying software services inside containers can help isolate the software services from one another, which can improve speed and security and provide other benefits.

Containers are deployed from image files using a container engine, such as Docker or Podman. These image files are often referred to as container images. A container image can be conceptualized as a stacked arrangement of layers in which a base layer is positioned at the bottom and other layers are positioned above the base layer. The other layers may include a target software service and its dependencies, such as its libraries, binaries, and configuration files. The target software service may be configured to run (e.g., on a guest operating system) within the isolated context of the container.

### BRIEF DESCRIPTION OF THE DRAWINGS

FIG. 1 is a block diagram of an example of a computing environment for mapping one or more processes to individual container layers according to some examples of the present disclosure.

FIG. 2 is a block diagram of an example of another computing environment for mapping one or more processes to individual container layers according to some examples of the present disclosure.

FIG. 3 is a block diagram of an example of a computing device for mapping one or more processes to individual container layers according to some examples of the present disclosure.

FIG. 4 is a flowchart of a process for mapping one or more processes to individual container layers in a computing environment according to some examples of the present disclosure.

### DETAILED DESCRIPTION

Containerized computing environments have become increasingly popular. For example, a containerized computing environment can use one or more containers to run software applications or processes in a relatively isolated virtual environment. Each container can include one or more container layers positioned in a stacked arrangement where each container layer can provide a respective functionality. The container layers can implement modularity with respect to managing and optimizing the software applications or the processes associated with the containers, which can facilitate resource management or resource allocation. A typical container management system overseeing the containers may provide functionality to identify running process of a particular container. But, a respective relationship between each running process and a corresponding container layer of the container is unknown, thereby limiting modifications to and monitoring of a container at a layer level. Additionally, a process may generate one or more child processes that can each generate one or more additional processes. Generational relationships between processes can make it difficult to determine which container layer initiated a particular process.

Some examples of the present disclosure can overcome one or more of the issues mentioned above by using a mapper service to map container processes to individual container layers. The mapper service can provide increased transparency regarding the individual container layers, which can facilitate container management and modularity. To map the container processes to the container layers, the mapper service can determine a set of processes associated with a container. In some cases, the container may be currently running in a containerized computing environment. The mapper service can use a monitoring program to monitor running processes that have been initiated based on a container image of the container. The container image can be a software package including one or more components (e.g., files, binaries, libraries, configurations, etc.) used to run the container. Additionally or alternatively, the mapper service may determine the set of processes for a container that is not currently running, such as using the container image related to the container. For instance, the mapper service can use a container file (e.g., a configuration file or a specification file) of the container to build each container layer of the container image. The container file can include instructions used to build the container. After building a particular container layer, the mapper service can determine a subset of the processes that were introduced by building the particular layer.

Once the mapper service determines the set of processes associated with the container, the mapper service can map each process in the set of processes to a corresponding container layer of the container. The mapper service may generate a mapping file that can indicate a respective mapping linking each process to the corresponding container layer. In some cases, the mapper service can use pattern matching to match metadata or other information associated with a particular process to a software application initiated by a particular container layer. Based on the pattern matching, the mapper service can map the particular process to the particular container layer. Additionally or alternatively, after building a particular container layer, the mapper service can determine which processes were initiated based on building the particular container layer. Consequently, the mapper service can link the initiated processes to the particular container layer.

In one particular example, an orchestration system of a containerized computing environment can execute a mapper service to generate a mapping file. The mapping file can indicate a respective relationship between each process of a container running in the containerized computing environment and a corresponding container layer of the container. The mapper service can use a container identifier related to the container to determine one or more processes that are running in the containerized computing environment and associated with the container. In particular, each process instantiated by a respective container layer of the container can include the same container identifier. Once the mapper service determines the processes associated with the container, the mapper service can use pattern matching, such as using a regular expression (regex), to assign each process to a corresponding container layer.

Based on the pattern matching, the mapper service can generate one or more mappings included in the mapping file that can indicate the respective relationship between each process of the container and the corresponding container layer. The mapping file can be used to facilitate access control, such as role-based access control. In particular, role-based access control may be implemented to prevent an owner of the container from creating processes with access permissions incompatible with an access role of the owner. For instance, the access role of the owner may indicate that the owner has read permission and write permissions but not execute permissions. If a particular container layer of the container uses execute permissions, the access permissions of the owner can be incompatible with the execute permissions of the particular container layer. Based on the access permissions of the owner being incompatible with the particular container layer, the orchestration system can disallow the particular container layer, such as by deactivating the particular container layer. In some cases, the orchestration system may replace the particular container layer with a different container layer that is compatible with the read and write permissions corresponding to the access role of the owner of the container. The orchestration system can select the different container layer to provide similar or the same functionality as the replaced container layer while using different access permissions that are compatible with the access role of the owner.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

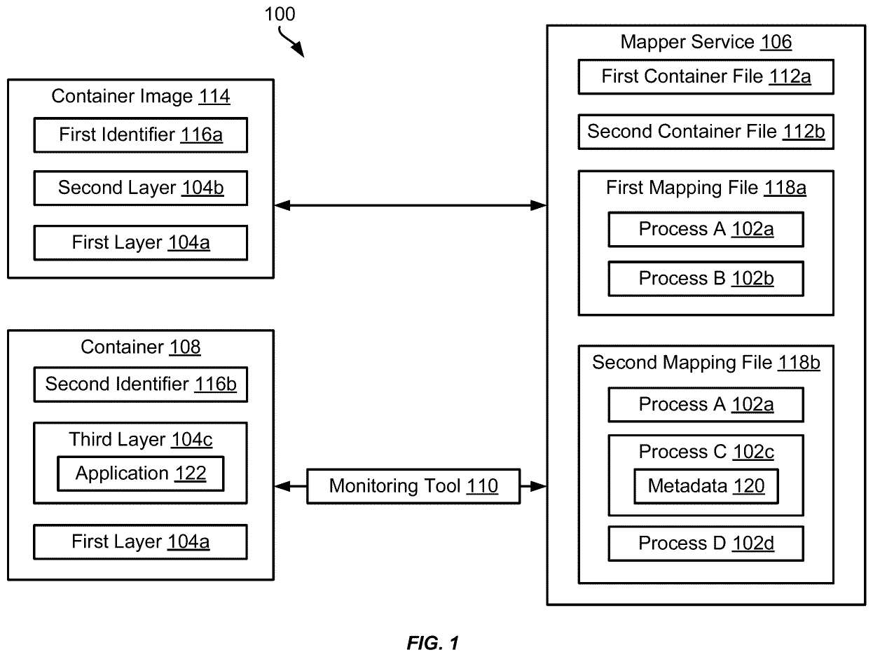

FIG. 1 is a block diagram of an example of a computing environment 100 for mapping one or more processes 102 to individual container layers 104 according to some examples of the present disclosure. In some examples, the computing environment 100 can be a distributed computing environment (e.g., a cloud computing environment, a computing cluster, etc.). Components within the computing environment 100 may be communicatively coupled, such as via a network (e.g., a local area network (LAN), wide area network (WAN), the Internet, etc.) or communication protocols. For example, the computing environment 100 can include a mapper service 106 that can monitor a container 108 in the computing environment 100 using a monitoring tool 110 (e.g., an extended Berkeley Packet Filter (eBPF)). The monitoring tool can include or run one or more programs within an operating system related to the container 108 to provide observability or monitoring functionality, such as to track resource consumption of the container 108 over time. In some implementations, the computing environment 100 can be hosted using one or more computing devices. Examples of a computing device can include a desktop computer, laptop computer, server, mobile phone, or tablet.

In some examples, the mapper service 106 can use a container file 112 (e.g., a first container file 112a) to determine the processes 102 to map to individual container layers 104, such as a first container layer 104a or a second container layer 104b. The container file 112 can be an executable file that can automate a process of creating a container image 114. The container image 114 can be a static, executable file that can include components, such as one or more files, libraries, dependencies, or metadata, used to build the container layers 104a-b. Once the container image 114 is executed (e.g., by a container engine), the container image 114 can be used to run a container that runs in the computing environment 100. For example, the container image 114 can contain suitable files to execute a particular operating system as part of the container. Executing the container image 114 can involve running one or more processes in an isolated portion of the computing environment 100 as part of the container. Each process generated using the container image 114 can be associated with a first container identifier 116a that can indicate which processes correspond to the container image 114.

In some implementations, the mapper service 106 can decompose the first container file 112a to build the container layers 104a-b of the container image 114. For example, the first container file 112a can include one or more lines of code. A respective subset (e.g., each line of code) of the code included in the first container file 112a can correspond to a respective container layer of the container image 114. As shown in FIG. 1, the container image 114 can include the first container layer 104a as a base layer and the second container layer 104b built on top of the first container layer 104a. As an example, the mapper service 106 can determine which processes of the container image 114 are introduced by the second container layer 104b, such as by examining an operating system of the container image 114. The mapper service can compare a list of processes running in the operating system after building the first container layer 104a with an updated list of processes running after building the second container layer 104b. The mapper service 106 can assign any new processes in the updated list of processes to the second container layer 104b. Based on building the container layers 104a-b, the mapper service 106 can generate a first mapping file 118a linking each process of the processes 102a-b to a respective container layer (e.g., the first container layer 104a or the second container layer 104b).

As an example, after the first container layer 104a is built, the mapper service 106 can determine that process A 102a is running as part of the operating system. The mapper service 106 then can map process A 102a to the first container layer 104a. As another example, after the first container layer 104a and the second container layer 104b are built, the mapper service 106 can determine that both process A 102a and process B 102b are running. Consequently, the mapper service 106 can determine that process B 102b is a new process introduced by building the second container layer 104b. Accordingly, the mapper service 106 can assign process B 102b to the second container layer 104b. In other words, a list of existing processes can be compared with an updated list of processes determined after each container layer of the container image 114 is generated to determine whether the updated list of processes includes one or more new processes. The mapper service 106 can attribute, assign, map, or otherwise associate the new processes with the container layer associated with the updated list of processes.

Additionally or alternatively, in some examples, the mapper service 106 can map one or more container processes of a container 108 that is currently running in the computing environment 100 to container layers 104 of the container 108. As shown in FIG. 1, the container 108 can include the first container layer 104a and a third container layer 104c built on the first container layer 104a. Other arrangements or amounts of container layers are possible. Each container layer may generate at least one process 102. The container 108 can include a collection of processes (e.g., process A 102a, process C 102c, and process D 102d) initiated in the computing environment 100 based on a container image. Each process associated with the container 108 can include a container identifier, such as a second container identifier 116b, corresponding to the container 108. The mapper service 106 can determine which processes in the computing environment 100 are associated with the container 108 based on the second container identifier 116b. In some examples, the container 108 shown in FIG. 1 can be different from a container generated using the container image 114. For example, the container 108 and the container image 114 include different container layers.

In some implementations, the mapper service 106 can use the monitoring tool 110 (e.g., an extended Berkeley Packet Filter (eBPF)) to monitor the processes 102 of the container 108, such as while the processes 102 are running in the computing environment 100. The monitoring tool 110 can collect monitoring data related to the processes 102, such as with respect to resource consumption, computational costs, energy costs, or a combination thereof. For example, the monitoring data can indicate a respective resource consumption of the processes 102, such as with respect to processing power, memory, storage, etc. In some examples, the monitoring tool 110 can include one or more software programs that are run based on an event that occurs. Examples of the event can include system calls, network events, kernel tracepoints, etc. As an example, the monitoring tool 110 can include tracing programs that can be attached to specific functions in a kernel used by the container 108. The tracing programs can collect information related to the specific functions, such as data that the specific functions are processing or system resources (e.g., storage, processing power, etc.) consumed by the specific functions.

Using the monitoring tool 110, the mapper service 106 can identify one or more software applications or one or more commands included in a container file related to the container 108, such as a second container file 112b. The mapper service 106 can analyze the information collected by the monitoring tool 110 to determine which software application or command initiated a corresponding process. Determining a relationship between a process and a specific container layer can involve determining that the process is related to a software application generated by the specific container layer.

In some examples, the mapper service 106 can implement pattern matching to compare information, such as metadata, related to a particular process with the software applications or the commands. For example, the mapper service 106 can compare metadata 120 of process C 102c with an application name of a software application 122 initiated by a third container layer 104c included in the container 108. The metadata 120 can include descriptive metadata (e.g., a process name of process C 102c), administrative metadata (e.g., access permissions, creation date, etc.), or other suitable types of metadata. Pattern matching can involve generating a similarity score that can indicate a degree of similarity between two or more sequences of characters. For example, the mapper service 106 may map process C 102c to the third container layer 104c based on the similarity score of the process name and the application name exceeding a predefined threshold. Accordingly, the mapper service 106 can determine a respective mapping between each process and a respective container layer of the container 108.

Additionally or alternatively, the mapper service 106 can analyze a specification file of the software application 122 to assign processes of the container 108 to individual container layers. In some cases, the specification file can include information related to the software application 122, such as system resources, configurations, etc. Additionally, the specification file can indicate which processes are instantiated by the software application 122. Based on the specification file, the mapper service 106 can link the processes instantiated by the software application 122 to a particular container layer (e.g., the third container layer 104c) of the container 108 that relates to the software application 122. In some examples, the specification file may indicate that the software application 122 can generate or initiate one or more additional applications. Based on the specification file, the mapper service 106 can link each process associated with the additional applications to the software application 122 and to a corresponding container layer (e.g., the third container layer 104c).

Once the mapper service 106 determines a respective relationship between each process of the container 108 and a corresponding container layer of the container 108, the mapper service 106 can generate a mapping file, such as a second mapping file 118b. The second mapping file 118b can include a respective mapping that links process A 102a, process C 102c, and process D 102d to the corresponding container layer (e.g., the first container layer 104a or the third container layer 104c). In some cases, more than one process can be assigned to the same container layer. For example, process C 102c and process D 102d may both be assigned to the third container layer 104c.

While FIG. 1 depicts a specific arrangement of components, other examples can include more components, fewer components, different components, or a different arrangement of the components shown in FIG. 1. For example, in other implementations, the container 108 or the container image 114 may include a different number of container layers. As another example, in other implementations, the computing environment 100 may include a container engine that can execute the mapper service 106. Additionally, any component or combination of components depicted in FIG. 1 can be used to implement the process(es) described herein.

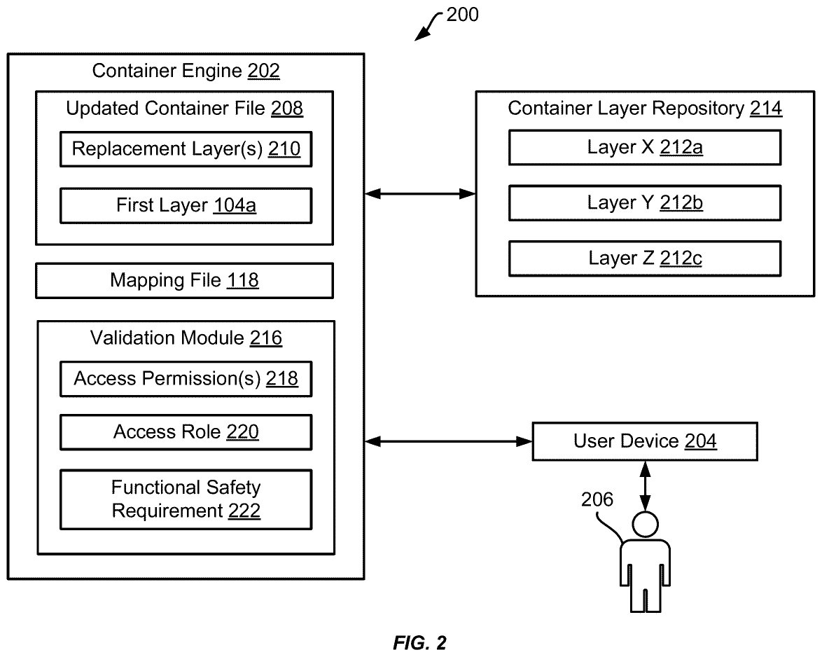

FIG. 2 is a block diagram of another example of a computing environment 200 for mapping one or more processes (e.g., the processes 102a-d of FIG. 1) to individual container layers 104 according to some examples of the present disclosure. In some examples, components shown in FIG. 2 can be part of the computing environment 100 of FIG. 1. Certain aspects of FIG. 2 are described below with reference to components of FIG. 1.

As shown, the computing environment 200 can include a container engine 202 (e.g., Docker, Podman, etc.) that can facilitate container deployment, such as building or running one or more containers. Additionally or alternatively, the container engine 202 may be part of or in communication with an container orchestration system that can facilitate container management, such as with respect to managing or scheduling a lifecycle of the containers, etc. As an example, the container engine 202 may receive user input from a user device 204 to modify the computing environment 200, such as by running a particular container. The user input can be generated by a user 206 interacting with the user device 204, such as via an input device (e.g., a mouse, a touchscreen, a keyboard, etc.).

In some aspects, the container engine 202 can generate an updated container file 208 that can include one or more replacement container layers 210 that can replace a noncompliant container layer. For example, the updated container file 208 shown in FIG. 2 can be an updated version of the first container file 112a or the second container file 112b of FIG. 1. As shown, the updated container file 208 includes a first container layer 104a and the replacement container layer(s) 210, where the first container layer 104a was previously provided in the first container file 112a and the second container file 112b. Other implementations are possible. For example, the noncompliant container layer that is replaced may be positioned between two compliant container layers previously included in a container file. As another example, the noncompliant container layer can be a base layer or a first layer of a container file.

In some cases, the replacement container layer(s) 210 can be selected from one or more equivalent container layers 212 that can be stored in a container layer repository 214 accessible by the container engine 202. As shown in FIG. 2, the container layer repository 214 includes a first equivalent container layer 212a, a second equivalent container layer 212b, and a third equivalent container layer 212c. Other quantities or configurations are possible. In some examples, the equivalent container layers 212 may provide similar or the same functionality. In other examples, each equivalent container layer may provide a different functionality that is equivalent to (e.g., similar to or the same as) another container layer included in a particular container file, a particular container image, or a particular container.

The container engine 202 can retrieve a subset of the equivalent container layers 212 from the container layer repository 214 as the replacement container layer(s) 210 to generate the updated container file 208. In some examples, the container engine 202 can have a respective set of layer options associated with each functionality. For example, a table that identifies which container layers are functionally equivalent (e.g., have the same or similar functionality) can be provided to or otherwise accessible by the container engine 202. As another example, the equivalent container layers 212 stored in the container layer repository 214 can have annotations to tag which container layers are functionally equivalent. The container engine 202 can use the table or the annotations to select the replacement container layer(s) 210 to swap with the noncompliant container layer to generate the updated container file 208. Generating the updated container file 208 can involve replacing the noncompliant container layer with the replacement container layer(s) 210 and rebuilding each container layer positioned subsequent to the noncompliant container layer.

In some examples, artificial intelligence or machine-learning can be implemented to select or assist with selecting the replacement container layer(s) 210. For example, a machine-learning model can be trained using training data to generate an output that can provide a recommendation related to the replacement container layer(s). The training data can include historical data corresponding to previous replacements made to generate historical updated container files. In some cases, the training data can relate to different scenarios for which replacing a container layer would occur. Examples of the different scenarios are further described herein. For example, a subset of the training data can relate to swapping out a container layer that is noncompliant with a functional safety standard. The subset of the training data can include labeled training inputs and labeled training outputs such that the machine-learning model can learn to output a recommendation indicating a replacement container layer 210 that is compliant with the functional safety standard. As another example, a subset of the training data can relate to replacing a container layer that is noncompliant with access permissions associated with the user 206. Similarly, the subset of the training data can include labeled training inputs and outputs such that the machine-learning model can learn to output a recommendation indicating a replacement container layer 210 that is compliant with the access permissions. Accordingly, the machine-learning model may be trained to determine a reason to replace the container layer and use the reason to generate or tailor its recommendation.

In some examples, the container engine 202 can implement access control, such as role-based access control. Implementing access control can prevent individual container layers of a container from accessing unauthorized resources, which can provide greater granularity of access control compared to restricting access by the entire container. As an example, the container engine 202 can execute a validation module 216 that can determine a set of access permissions 218 associated with each process of a container image (e.g., the container image 114 of FIG. 1). Examples of the access permissions 218 can include read permissions, write permissions, read/write permissions, execute permissions, delete permissions, etc.

Once the validation module 216 obtains the access permissions 218, the validation module 216 can use a mapping file 118 to verify whether a user associated with the container image is authorized to create each process. For example, the user input provided by the user 2106 via the user device 204 may instruct the container engine 202 to retrieve the container image from an image repository that can store one or more container images. Before executing the container image, the container engine 202 can run the validation module 216 to validate the access permissions 218 used by processes that would be initiated by the container image. In particular, the validation module 216 can determine whether the access permissions 218 of the processes are compliant with an access role 220 of the user 206. The user 206 can be assigned the access role 220 by an administrator to indicate specific access permissions afforded to the user 206.

In some implementations, the validation module 216 can use the mapping file 118 to determine that a particular container layer (e.g., a first container layer 104a) of a container file is noncompliant with the access role 220. The validation module 216 can identify a noncompliant process that uses access permissions 218 that are noncompliant with the specific access permissions of the access role 220, such as using the container file. For example, the noncompliant process may have write permissions, whereas the access role 220 only provides read permissions. Once the noncompliant process is identified, the validation module 216 can use the mapping file 118 to determine the particular container layer used to initiate the noncompliant process. In some examples, the container engine 202 may remove the particular container layer and generate the updated container file 208. In other examples, the container engine 202 can replace the particular container layer in the container file with a replacement container layer 210 that is compliant with the specific access permissions of the access role 220. For example, the container engine 202 can select the equivalent container layer 212 based on the equivalent container layer 212 providing similar or the same functionality as the replaced container layer while being compliant with the access role 220. Accordingly, the container engine 202 can generate an updated container file 208 that can include the equivalent container layer 212 and one or more existing layers that are compliant with the specific access permissions of the access role 220. For example, the first container layer 104a can be considered an existing container layer in the updated container file 208.

In some examples, the container engine 202 can execute the validation module 216 to determine whether any processes in the container file are noncompliant with a functional safety requirement 222. Functional safety relates to reducing risks so that computing components function safely in an event of a malfunction. The functional safety requirement can correspond to a functional safety standard that can correspond to a target level of risk reduction to minimize a likelihood of hazardous operational situations. Software deployed in containers can be certified to a particular functional safety standard based on meeting or exceeding the functional safety requirement(s) 222 of the particular functional safety standard. Functional safety analysis typically involves determining functional safety compliance at a container level, such as by determining that the container is overall compliant with the functional safety requirement 222. But, individual container layers of a compliant container may not necessarily be compliant with the functional safety requirement 222.

The validation module 216 can determine that a particular container layer of the container file is noncompliant with the functional safety requirement 222. For example, referring to aspects of FIG. 1, the validation module 216 may determine that the second container layer 104b of the first container file 112a is noncompliant with the functional safety requirement 222. Based on the particular container layer being noncompliant, the container engine 202 can select a compliant container layer from the equivalent container layers 212 as the replacement container layer 210 to generate the updated container file 208. In particular, the compliant container layer can be compliant with the functional safety requirement 222 while providing similar or the same functionality as the noncompliant container layer that is being replaced with the compliant container layer. Once the container engine 202 obtains the compliant container layer, the container engine 202 can update the container file to generate the updated container file 208 that replaces the noncompliant container layer with the compliant container layer. The container engine 202 can execute the updated container file 208 to generate an updated container that is compliant with the functional safety requirement 222.

In some implementations, a problematic container layer (e.g., a noncompliant container layer) can be replaced with more than one container layer. For example, the problematic container layer can be a container layer that is overloaded, such as due to the container layer being configured to generate a number of processes that exceeds a predefined threshold. In particular, the container layer being configured to generate a relatively large number of processes can be indicative of a compromised container layer that can execute a distributed denial-of-service (DDoS) attack. The processes generated by the compromised container layer can overwhelm one or more components of the computing environment 200, such as a machine hosting a container with the compromised container layer. More specifically, resource consumption of the processes can prevent other processes in the computing environment 200 from accessing sufficient system resources to function properly. Consequently, the other processes may be unable to provide certain services or functionality, such as to maintain a secure computing environment or to communicate with hardware devices.

The container engine 202 can identify an overloaded container layer using a container file associated with the overloaded container layer. For example, the container engine 202 can determine the number of processes associated with the overloaded container layer and compare the number of processes to the predefined threshold. Based on the number of processes exceeding the predefined threshold, the container engine 202 can identify the overloaded container layer. Once the overloaded container layer is identified, the container engine 202 may disallow the overloaded container layer, such as to prevent resource exhaustion. Disallowing the overloaded container layer can include removing the overloaded container layer from the container file or otherwise deactivating the overloaded container layer. Additionally or alternatively, the container engine 202 can select a set of container layers to replace the overloaded container layer. For example, the overloaded container layer can be broken down to generate the set of container layers to replace the overloaded container layer. As an example, if the updated container file 208 is an updated version of the first container file 112a of FIG. 1, the updated container file 208 can include a set of replacement container layers 210 to replace the second container layer 104b.

In some examples, the set of replacement container layers 210 can include any container layer stored in the container layer repository 214 or any suitable combination thereof. For example, the overloaded container layer can provide a particular set of functionalities, which can include a validation functionality and a logging functionality. The overloaded container layer can be split into a respective subset of replacement container layers 210 related to each functionality in the particular set of functionalities. In particular, the overloaded container layer can be replaced with a subset of replacement container layers 210 providing the validation functionality and another subset of replacement container layers 210 providing the logging functionality.

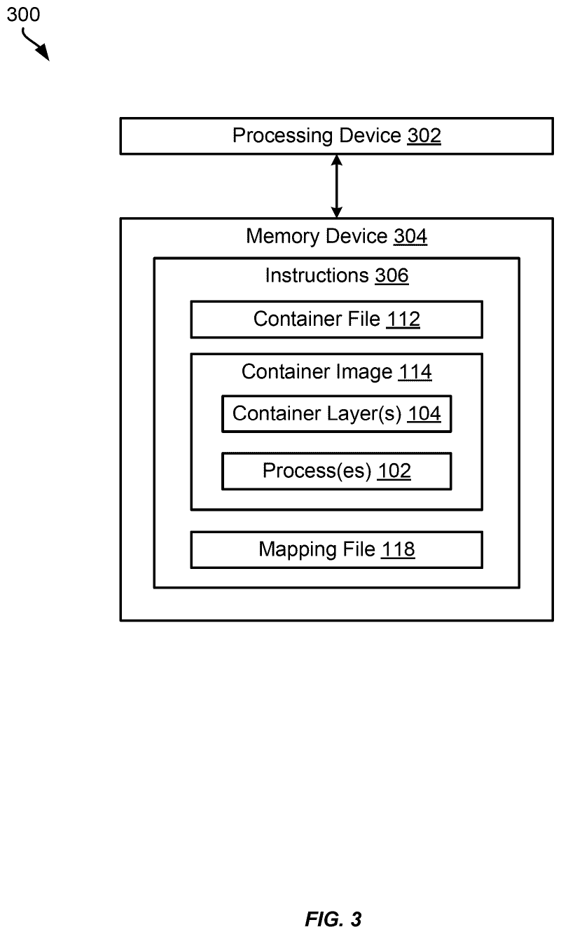

FIG. 3 is a block diagram of an example of a computing device 300 for mapping one or more processes 102 to individual container layers 104 according to some examples of the present disclosure. The computing device 300 can include a processing device 302 communicatively coupled to a memory device 304. Certain aspects of FIG. 3 are described below with reference to components of FIG. 1.

The processing device 302 can include one processing device or multiple processing devices. The processing device 302 can be referred to as a processor. Non-limiting examples of the processing device 302 include a Field-Programmable Gate Array (FPGA), an application-specific integrated circuit (ASIC), and a microprocessor. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C #, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processing device 302 can read instructions 306. A computer-readable medium can include electronic, optical, magnetic, or other storage devices capable of providing the processing device 302 with the instructions 306 or other program code. Non-limiting examples of a computer-readable medium include magnetic disk(s), memory chip(s), ROM, random-access memory (RAM), an ASIC, a configured processor, and optical storage.

In some examples, the processing device 302 can execute a mapper service 106 to map the processes 102 to a respective container layer of a container image 114. The processing device 302 can receive or otherwise access a container file 112 executable to generate one or more container layers 104 of a container image 114. In other words, the container file 112 can specify a configuration of the container image 114, such as with respect to building the container layers 104 to generate the container image 114. The processing device 302 additionally can determine one or more processes 102 associated with the container image 114. Each process can be generated by a respective container layer of the container file 112. In some examples, as described herein, the processing device 302 may determine the processes 102 initiated by the container image 114 by using the container file 112 to build each container layer. In particular, the processing device 302 can determine a respective set of the processes 102 generated subsequent to building each container layer. Accordingly, the processing device 302 can determine a respective mapping of each process to a corresponding container layer. The processing device 302 then can generate a mapping file 118 indicating the respective mapping of each process to its corresponding container layer.

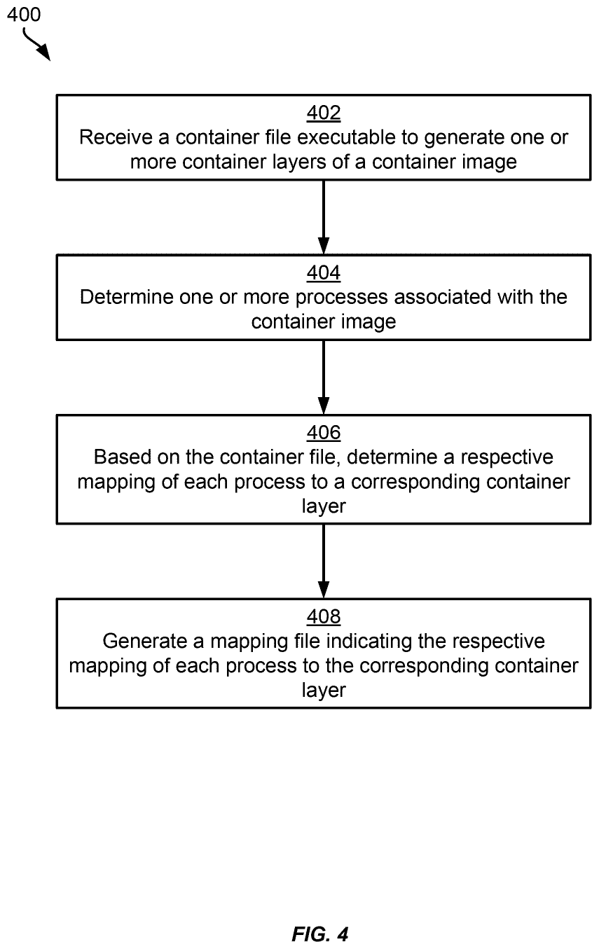

FIG. 4 is a flowchart of a process 400 for mapping one or more processes 102 to individual container layers 104 in a computing environment (e.g., the computing environment 100 of FIG. 1) according to some examples of the present disclosure. In some examples, the processing device 302 can perform one or more of the steps shown in FIG. 4. In other examples, the processing device 302 can implement more steps, fewer steps, different steps, or a different order of the steps depicted in FIG. 4. The steps of FIG. 4 are described below with reference to components discussed above in FIGS. 1-3.

In block 402, the processing device 302 receives a container file 112 executable to generate one or more container layers 104 of a container image 114 in a computing environment 100. In some examples, the processing device 302 can use the container file 112 to generate the container image 114. For example, the processing device 302 can execute a container engine 202 that can read instructions included in the container file 112 to automatically create the container image 114. Creating the container image 114 can involve building the container layers 104 in a stacked arrangement, thereby forming the container image 114. In some examples, the processing device 302 can use the container file 112 to build each container layer of the container image 114 in a stacked arrangement, for example such that a subsequent container layer is built on one or more previous container layers.

In block 404, the processing device 302 determines one or more processes 102 associated with the container image 114 in the computing environment 100. Each process of the one or more processes 102 can be generated by a respective container layer of the container file 112. In some examples, the processing device 302 can determine the processes 102 by building each container layer, such as using the container file 112. More specifically, by discretely building each container layer, the processing device 302 can narrow down a respective subset of the processes 102 corresponding to each container layer. For example, subsequent to building a first container layer 104a, the processing device 302 can determine a difference in processes that are currently available compared to processes that were previously available before building the first container layer 104a. The respective subset of the processes 102 corresponding to the first container layer 104a can be determined based on the difference.

In other examples, the processing device 302 can determine the processes 102 while the processes 102 are running or being executed. For example, the processing device 302 can execute the container image 114 to generate a container as a running instance of the container image 114. Generating the container can involve implementing or initiating the processes 102 that are part of the container layers 104 of the container image 114. In particular, each process initiated based on the container image 114 or the container file 112 can be identifiable using a container identifier 116. Accordingly, the processing device 302 can search for the container identifier 116 to determine the processes 102 associated with the container image 114 or the container file 112.

In block 406, the processing device 302, based on the container file 112, determines a respective mapping of each process to a corresponding container layer. In some examples, the processing device 302 can map a particular process to the corresponding container layer. For example, as described herein, the processing device 302 can build or rebuild the container layers 104 to determine the respective subset of the processes 102 initiated by each container layer. Additionally or alternatively, the processing device 302 can use a monitoring tool 110 to monitor the processes 102, such as with respect to resource consumption. The monitoring tool 110 can provide monitoring data to the processing device 302 that can include one or more identifiers (e.g., the container identifier 116) or metadata related to the processes 102. As an example, the monitoring data generated by the monitoring tool 110 can include a respective name associated with each process. The processing device 302 can perform pattern matching using each name of the processes 102 to determine a respective application associated with each name. The processing device 302 then can determine a corresponding container layer related to each application. Accordingly, the processing device 302 can map each process to its corresponding container layer.

In block 408, the processing device 302 generates a mapping file 118 indicating the respective mapping of each process to the corresponding container layer. In some examples, the processing device 302 can use the mapping file 118 to facilitate container management or customization, such as by enabling certain container layers to be replaced or otherwise modified. For example, the processing device 302 can use the mapping file 118 to implement resource allocation to the container layers 104 of the container image 114 based on the process(es) 102 associated with each container layer. As another example, the processing device 302 can use the mapping file 118 to facilitate functional safety compliance. In particular, once the processing device 302 determines that a particular process is noncompliant with a functional safety requirement 222, the processing device can use the mapping file 118 to determine which container layer generates the particular process. The processing device 302 then can replace the noncompliant container layer with a different container layer that is compliant with the functional safety requirement 222. In some implementations, the processing device 302 can select the different container layer based on the compliant container layer providing similar or the same functionality as the noncompliant container layer while being compliant with the functional safety requirement 222.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving a container file executable to generate one or more container layers of a container image in a computing environment;
determining one or more processes associated with the container image in the computing environment, each process of the one or more processes generated by a respective container layer of the container file;
based on the container file, determining a respective mapping of each process of the one or more processes to a corresponding container layer of the one or more container layers; and
generating a mapping file indicating the respective mapping of each process to the corresponding container layer.

2. The system of claim 1, wherein the operations further comprise:
determining the one or more processes associated with the container image based on a container identifier associated with the container image, wherein each process initiated by the container image is identifiable using the container identifier.

3. The system of claim 1, wherein determining the respective mapping of each process comprises:
determining, for a particular process using the container file, that metadata of the particular process is related to an application provided by a particular container layer of the one or more container layers; and
in response to determining that the metadata of the particular process is related to the application provided by the particular container layer, mapping the particular process to the particular container layer to indicate that the particular process is initiated by the particular container layer.

4. The system of claim 1, wherein determining the one or more processes associated with the container image comprises:
using the container file, building each container layer of the container image, wherein a subsequent container layer is built on one or more previous container layers; and
based on building each container layer, determining, for each container layer built, a respective set of processes introduced by the container layer.

5. The system of claim 1, wherein the operations further comprise:
determining a respective set of access permissions associated with each process of the one or more processes of the container image; and
verifying, using the mapping file, whether a user of the container image is authorized to create each process of the one or more processes.

6. The system of claim 1, wherein the operations further comprise:
determining that a particular container layer of the one or more container layers is noncompliant with a functional safety requirement;
in response to determining that the particular container layer is noncompliant with the functional safety requirement, selecting a compliant container layer that is compliant with the functional safety requirement from a set of equivalent container layers providing similar functionality as the noncompliant container layer; and
updating the container file to replace the noncompliant container layer with the compliant container layer.

7. The system of claim 1, wherein the operations further comprise:
determining that a particular container layer of the one or more container layers is overloaded based on the particular container layer being configured to generate a number of processes that exceeds a predefined threshold;
selecting a set of container layers to replace the particular container layer, wherein each container layer in the set of container layers is configured to generate a respective subset of the processes configured to be generated by the particular container layer; and
updating the container file to replace the particular container layer with the set of container layers.

8. A method comprising:
receiving a container file executable to generate one or more container layers of a container image in a computing environment;
determining one or more processes associated with the container image in the computing environment, each process of the one or more processes generated by a respective container layer of the container file;
based on the container file, determining a respective mapping of each process of the one or more processes to a corresponding container layer of the one or more container layers; and
generating a mapping file indicating the respective mapping of each process to the corresponding container layer.

9. The method of claim 8, further comprising:
determining the one or more processes associated with the container image based on a container identifier associated with the container image, wherein each process initiated by the container image is identifiable using the container identifier.

10. The method of claim 8, wherein determining the respective mapping of each process comprises:
determining, for a particular process using the container file, that metadata of the particular process is related to an application provided by a particular container layer of the one or more container layers; and
in response to determining that the metadata of the particular process is related to the application provided by the particular container layer, mapping the particular process to the particular container layer to indicate that the particular process is initiated by the particular container layer.

11. The method of claim 8, wherein determining the one or more processes associated with the container image comprises:
using the container file, building each container layer of the container image, wherein a subsequent container layer is built on one or more previous container layers; and
based on building each container layer, determining, for each container layer built, a respective set of processes introduced by the container layer.

12. The method of claim 8, further comprising:
determining a respective set of access permissions associated with each process of the one or more processes of the container image; and
verifying, using the mapping file, whether a user of the container image is authorized to create each process of the one or more processes.

13. The method of claim 8, further comprising:
determining that a particular container layer of the one or more container layers is noncompliant with a functional safety requirement;
in response to determining that the particular container layer is noncompliant with the functional safety requirement, selecting a compliant container layer that is compliant with the functional safety requirement from a set of equivalent container layers providing similar functionality as the noncompliant container layer; and
updating the container file to replace the noncompliant container layer with the compliant container layer.

14. The method of claim 8, further comprising:
determining that a particular container layer of the one or more container layers is overloaded based on the particular container layer being configured to generate a number of processes that exceeds a predefined threshold;
selecting a set of container layers to replace the particular container layer, wherein each container layer in the set of container layers is configured to generate a respective subset of the processes configured to be generated by the particular container layer; and
updating the container file to replace the particular container layer with the set of container layers.

15. A non-transitory computer-readable medium comprising program code executable by a processing device for causing the processing device to perform operations comprising:
receiving a container file executable to generate one or more container layers of a container image in a computing environment;
determining one or more processes associated with the container image in the computing environment, each process of the one or more processes generated by a respective container layer of the container file;
based on the container file, determining a respective mapping of each process of the one or more processes to a corresponding container layer of the one or more container layers; and
generating a mapping file indicating the respective mapping of each process to the corresponding container layer.

16. The non-transitory computer-readable medium of claim 15, wherein the operations further comprise:
determining the one or more processes associated with the container image based on a container identifier associated with the container image, wherein each process initiated by the container image is identifiable using the container identifier.

17. The non-transitory computer-readable medium of claim 15, wherein determining the respective mapping of each process comprises:
determining, for a particular process using the container file, that metadata of the particular process is related to an application provided by a particular container layer of the one or more container layers; and
in response to determining that the metadata of the particular process is related to the application provided by the particular container layer, mapping the particular process to the particular container layer to indicate that the particular process is initiated by the particular container layer.

18. The non-transitory computer-readable medium of claim 15, wherein determining the one or more processes associated with the container image comprises:
using the container file, building each container layer of the container image, wherein a subsequent container layer is built on one or more previous container layers; and
based on building each container layer, determining, for each container layer built, a respective set of processes introduced by the container layer.

19. The non-transitory computer-readable medium of claim 15, wherein the operations further comprise:
determining a respective set of access permissions associated with each process of the one or more processes of the container image; and
verifying, using the mapping file, whether a user of the container image is authorized to create each process of the one or more processes.

20. The non-transitory computer-readable medium of claim 15, wherein the operations further comprise:
determining that a particular container layer of the one or more container layers is noncompliant with a functional safety requirement;
in response to determining that the particular container layer is noncompliant with the functional safety requirement, selecting a compliant container layer that is compliant with the functional safety requirement from a set of equivalent container layers providing similar functionality as the noncompliant container layer; and
updating the container file to replace the noncompliant container layer with the compliant container layer.
